(19) United States
(12) Patent Application Publication
(10) Pub. No.: US 2005/0185970 A1
(43) Pub. Date: Aug. 25, 2005

(54) Reset free devices

(76) Inventors: Christi Kay Madsen, South Plainfield, NJ (US); Albert Georg Peter Oswald, Berkeley Heights, NJ (US)

Correspondence Address: Mr. Bruce S. Schneider, 1153 Long Hill Road, Stirling, NJ, 07980-1007, US

(21) Appl. No.: 10/783,516

(22) Filed: Feb. 20, 2004

(51) Int. Cl. H04B 10/06

(52) U.S. Cl. 398/202

(57) ABSTRACT

It is possible to perform reset free operation in devices having polarization state controllers by employing specific sequences of phase shifters and couplers. In particular, sequences comprising a coupler/phase shifter/coupler or phase shifter/coupler/phase shifter formed in, for example, a semiconductor substrate, e.g. silicon substrate, are used to form the polarization state controller. A sequence functions as a quarter wave plate equivalent while two combined sequences function as a half wave plate. Control of the couplers and phase shifters of these sequences yield reset free operation.

### TECHNICAL FIELD

This invention relates to optical communication and in particular optical communication involving polarization mode effects.

### BACKGROUND OF THE INVENTION

In optical communication systems and in particular in long haul optical communications systems, dispersion effects, if uncorrected, cause significant bit error rates. Thus, a large variety of approaches have been developed to deal with such dispersion. (See Optical Fiber Telecommunications 111A, Chapters 6 and 7, Ed. by I. P. Kaminow and T. L. Koch, Academic Press, 1997 for a general description of dispersion effects in optical communication systems.) These approaches for correcting dispersion have been effective and as a result have allowed an increased rate of information transmission as well as an increased distance between points at which the signal is reshaped. However, as transmission pulse rates become faster and/or as distances between reshaping become greater, new effects resulting in dispersion become significant In particular, at data repetition rates above about 40 Gb/s and/or signal reshaping spaces greater than about 500 km polarization mode dispersion begins to present a concern.

Generally light launched for long haul communications on an optical medium such as a laser light from a distributed feedback laser, contains essentially only one polarization mode. Nevertheless coupling in the fiber soon produces two polarization modes with the injected light power divided between these two modes. Since the two modes do not travel at the same rate through the optical medium, the information contained in one polarization mode becomes spread in time relative to the other mode as it traverses the optical medium. Thus polarization mode dispersion adds to other undesirable dispersive effects.

For most optical media the difference in traversal rate between the two polarization modes, commonly denominated TE and TM, is relatively small—on the order of a few picoseconds. However, as previously discussed, at repetition rates approaching about 40 Gb/s or reshaping distances approaching about 500 km, even the relatively small difference between the traversal rates of the two polarization modes becomes meaningful. Thus, an increased interest in correcting polarization mode dispersion has been generated.

Before compensating for polarization mode dispersion, the polarization state of the incoming optical signal is desirably brought to the state of polarization that is advantageous for correction by the device being employed. Numerous approaches have been developed in optics to change the state of polarization in an incoming optical wave into a second desired state of polarization. For example, the sequence of a first quarter wave plate, a half wave plate, and a second quarter wave plate intercepting the light is employable to produce the transition from the input polarization state to a second desired output state. (See Heismann, Journal of Lightwave Technology, 12 (4), 696 (1994), which is hereby incorporated by reference in its entirety, for a description of this optical plate arrangement.) Each plate is rotated sufficiently around an axis through the center of and perpendicular to its major surface to achieve the desired conversion. For example, as shown schematically in FIG. 1, the three plates as indicated are rotated to an appropriate degree to produce the desired conversion. (The necessary degree of rotation for a given input state and desired output state is reliably calculated as described in Heismann, supra. By convention, the rotation angle of the first quarter wave plate is denominated α/2, the rotation of a half wave plate is denominated γ/2, and the rotation of the third wave plate denominated β/2.) However, the mechanical rotation of wave plates in response to an incoming signal having rapidly changing polarization states is not a practical approach to providing a desired output polarization state for dispersion correction.

A variety of devices that are the equivalent to the previously described three wave plate device but whose effect on polarization state is controlled by manipulation of an electrical signal have been proposed. For example, as discussed by Heismann, supra, a device equivalent to the three wave plate configuration is producible in a lithium niobate wafer. This device has the attribute of relatively fast conversion from one polarization state to another—speeds reported to be on the order of 4900 rad/s accompanying reset free polarization. (Reset free means that the device in operation converts a communication signal with varying incoming polarization states to desired output polarization states without using redundant polarization control elements such as phase shifters and/or couplers. A component in an optical polarization conversion circuit is redundant if an incoming constant polarization signal is convertible in the optical conversion circuit without the component but continuous conversion as the relative phase difference between the two polarizations of the incoming signal monotonically increases from 0 to 10 π requires at least intermittent use of this component.) Although such lithium niobate devices are indeed reset free and have conversion speeds significantly faster than that involved with wave plate configurations, they, nevertheless, rely on fabrication by techniques less adapted for mass production than that typically used in integrated circuit manufacture.

In an attempt to reduce cost and increase speed, polarization controllers for use in polarization mode dispersion compensation have been proposed to be fabricated as a silica based planar lightguide circuit. (See T. Saida et.al. IEEE Photonics Technology Letters, 14(4), 507 (2002)). Fabrication of devices such as tunable couplers, phase shifters, and polarization beam splitters are well-known as discussed in Optical Fiber Telecommunications IIIB, Ed. By Kaminow and Koch, Chapter 8 by Li and Henry. Since fabrication of individual components forming the polarization controller is well known and fabrication in a silicon/silica based medium is relatively inexpensive, such device has the potential for being significantly easier to fabricate than a device based on lithium niobate. Additionally, the speed of such device as demonstrated by Saida, et.al., is substantially faster than manual manipulation of wave plates, although improvement would be desirable for optical communication. Nevertheless, these silicon/silica based devices are not reset free, contain redundant components to convert polarization states and suffer polarization delays associated with reset. The phase shifters and tunable couplers produced using a substrate having silicon and silicon dioxide regions are controlled by electrodes configured to produce localized heating in appropriate device regions. The degree that the phase is shifted or the extent of coupling between light in two individual waveguides depends on the degree of heating. Clearly, material properties limit the extent of heating that is acceptable.

For the device and control process proposed by Saida, to produce reset free conversion from an incoming signal with a monotonically increasing polarization state to a output desired polarization state would result in exceeding this material property limitation. Thus, a redundant pair of phase shifters and tunable couplers is employed so that as the heating in one pair is reduced, to maintain acceptable operating conditions, the heaters in the other are increased to allow continuous maintenance of a desired output state. Thus the absence of a reset free environment generally slows the processing of complicated optical signals such as encountered in optical communication.

There is therefore a need for a device based on a material system such as silicon/silica that provides conventional fabrication, that is reset free, and that is suitable for silica based integration for compensation of polarization mode dispersion.

### SUMMARY OF THE INVENTION

By an appropriate choice of device components and an appropriate control protocol, it is possible to produce and operate a polarization mode dispersion compensator or other optical signal processing device having a reset free polarization controller formed in a semiconductor material substrate such as a silicon substrate. The device, because it is formed using a semiconductor based substrate, has the advantage of established fabrication procedures, is reset free and thus is fast enough to operate on input signals having typical polarization state variation encountered in optical communication.

The device includes tunable couplers and tunable phase shifters, e.g. thermo-optic couplers and thermo-optic phase shifters. (The invention is not limited to a particular kind of phase shifter or coupler and a variety of such components e.g. free carrier plasma, electro-optic phase shifters and/or multi-mode interference couplers, Journal of Lightwave Technology 13(4), 615 (1995), are employable. However in one advantageous embodiment, thermo-optic phase shifters and couplers are advantageously employed. Thus for pedagogic purposes only, the remainder of the description is in terms of such thermo-optic components.)

Both thermo-optic couplers and thermo-optic shifters employ electrodes to produce the heating required to control respectively the degree of phase shift and the degree of coupling. The desired change from an input polarization state to a desired output polarization state is achieved using as building blocks two types of component sequences. Specifically, in a first type sequence (denominated in the context of this invention Type I), a phase shifter then a coupler and then a phase shifter are used sequentially. In a second type sequence (Type II), a coupler, a phase shifter, and then a coupler are employed sequentially. The sequences are used to produce a result equivalent to a quarter wave plate. Since a half wave plate γ/2 is replaceable by two quarter wave plates γ/2, two of these sequences in a row (operated as identical quarter wave plates) are used to produce the result equivalent to a half wave plate. By using three sequences (for example, two of the same type sequence and one of another type sequence) in series and operating the first as a quarter wave plate equivalent and the second two together as a half wave plate equivalent it is possible to ensure that the output signal has a constant desired polarization state. By employing four sequences in series (two sequences operating as quarter wave plate equivalents separated by two sequences ganged together to operate as a half wave plate), any output polarization state is producible. The control of the degree of phase shift for the shifter(s) and the coupling strength for the coupler(s) for each individual sequence operated as quarter wave plate equivalent produces reset free operation. In the Type I sequence, the heaters are controlled to produce the desired quarter wave plate α/2 in conformance with the equation:
θ=arcsin [2^{-1/2} sin α]; φ₀=φ₁=arctan(cos α) (1)

Where θ is the coupling strength for the coupler, and φ₀ and φ₁ are the phase shifts for the shifter before and after the coupler, respectively.

In the Type II sequence, the electrodes are controlled in conformance with the equation:
φ/2=arcsin [2^{-1/2} cos α]; θ₀=φ₁=½]arctan(sin α) (2)

Where φ is the phase shift for the shifter, and θ₀ and θ₁ are the coupling strengths for the couplers before and after the shifter, respectively.

The exact output state achieved for a given set of plate rotations is well known as discussed in Heismann, supra and Kliger et.al., Polarized Light in Optics and Spectroscopy, Academic Press, 1990, Chapter 4 and appendix pages 282-283, which are hereby incorporated by reference in their entirety. Since both θ and φ are controlled for each sequence, a reset free operation is achievable. Thus the attributes of a reset free, semiconductor material based, responsive device are achievable in a configuration that is equivalent to well known wave plate configurations.

### BRIEF DESCRIPTION OF THE DRAWINGS

FIG. 1 is illustrative of wave plates employed to affect polarization states;

FIGS. 2 and 3 are illustrative of Type I and Type II sequences;

FIGS. 4 through 6 are illustrative of combinations of Type I and Type II sequences; and

FIG. 7 is illustrative of one embodiment of a coupler component

### DETAILED DESCRIPTION

It is possible to produce and operate a polarization state controller that is reset free, and capable of being formed using semiconductor device fabrication techniques such as those involving silicon and silicon dioxide. The output of such controller is further processed to achieve more complex optical signal processing such as polarization mode dispersion compensation. Generally, the signal is subjected first to a polarization beam splitter to divide the signal into its two polarization components. Then one of the two resulting output signals is subjected to a fixed half wave plate producing a 90 degree rotation. Accordingly, the incoming signal is prepared for the inventive device by splitting it into separate polarization components and rotating one component 90 degrees relative to the other. (Polarization beam splitters and fixed half wave plates such as formed from trenches filled with polyimide are well known. See Saida supra.) The two polarization components are introduced into the sequences, for example, at 57 and 58, respectively, in FIG. 5. Similarly, after treatment of the signal with the inventive device and if desired with other devices, such as a time delay devices, the polarization components are generally subjected to the inverse operation, i.e. the component previously rotated 90 degrees is rotated another 90 degrees and the components are again combined.

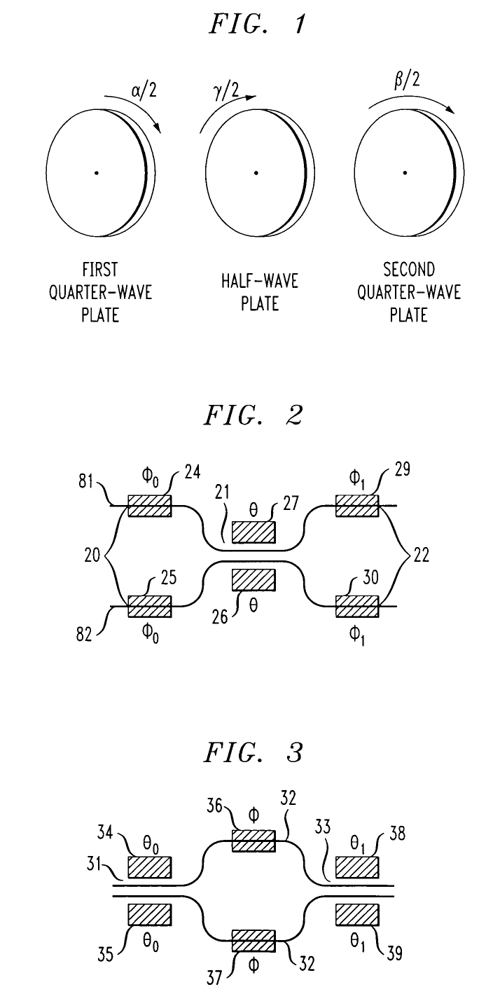

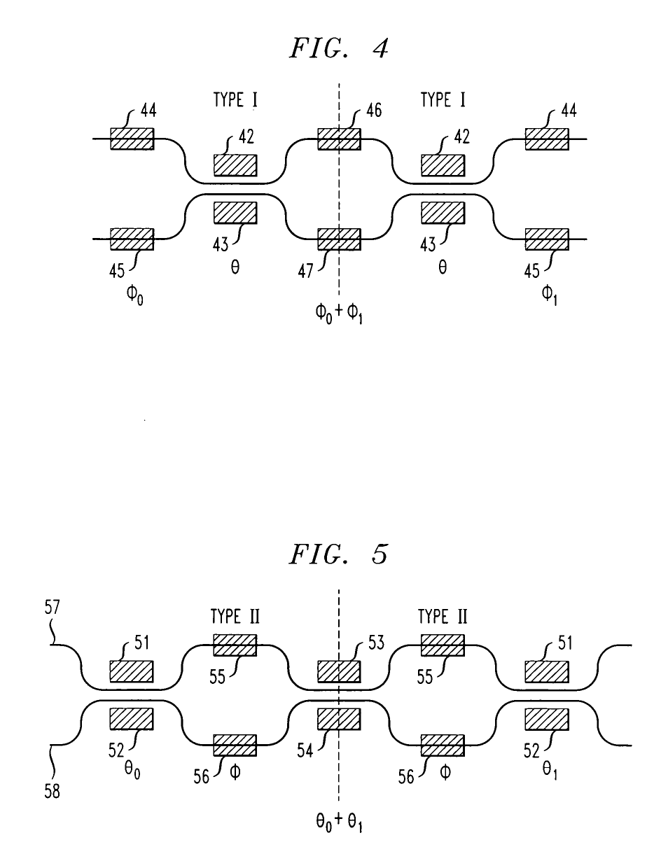

The inventive reset free processing devices involve use of polarization controllers composed of building blocks where each building block includes a specific sequence of variable phase shifters and variable directional couplers. In a Type I sequence shown in FIG. 2, the components used in sequence include a variable phase shifter 20, a variable coupler 21, and a second variable phase shifter 22. The variable coupler need not be formed from a single component For example, a variable coupler is producible using the configuration of FIG. 7. The waveguides, 71 and 72, form a fixed coupler 77 (coupling typically a fixed amount of power in the range 30 to 70 percent) a variable phase shifter 79 having electrodes 74 and 75 to control θfor the entire coupler equivalent and a second fixed coupler 78 complementary to coupler 77. The relationship between the phase shift induced by electrode 75 and 74 and the θ for the entire variable coupler equivalent is given in Madsen and Zhao, Optical Filter Design and Analysis, Chapter 4, pages 165 to 171, New York, Wiley (1999) which is hereby incorporated in its entirety by reference. For convenience, the entire set of components used to produce the variable coupler is denominated a coupler and is shown in the Figures by the representation shown in association with electrodes 42 and 43 in FIG. 4 or at 33 in FIG. 3.) Electrodes 24 and 25 in FIG. 2 control the first phase shifter, electrodes 26 and 27 control the coupler, and electrodes 29 and 30 control the second phase shifter. Each electrode is employed to heat the silica region of the device as is conventional with thermo-optic devices described in Kaminow and Koch, Chapter 8 supra. To produce positive values of φ₀, θ, and φ₁, electrodes 24, 27, and 29 are employed respectively. Correspondingly, to produce negative values of φ₀, θ, and φ₁, electrodes 25, 26 and 30, respectively are employed. The necessary heating and thus the necessary current imparted to the various electrodes to produce a desired value for φ and θ is easily determined using a control sample.

A Type II component sequence useful as a building block is shown in FIG. 3. The components used sequentially include a coupler 31, a phase shifter 32, and a second coupler 33. Again, electrodes 34, 35, 36, 37, 38, and 39 are used to produce the desired values for θ and φ where electrode 34, 36, and 38 are used to produce positive values while electrodes 35, 37, and 39 are employed to produce negative values.

Either a Type I or a Type II sequence functions as a quarter wave plate equivalent. By employing two sequences in series and operating them as identical quarter wave plates, it is possible to form a half wave plate equivalent Thus, as shown in FIG. 4 with two Type I sequences, electrodes 42, are electrically connected and are used to produce positive values for θ while electrically connected electrodes 43 are used to produce negative values of θ. Similarly, electrically connected electrodes 44 are used to produce positive values of φ₀, electrically connected electrodes 45 are used for negative φ₀, while electrodes 46 and 47 are used to produce positive and negative values respectively of φ₀ +φ₁. (It should be noted the φ₀ and φ₁ for half wave plates do not correspond strictly to couplers before and after the first phase shifter in the configuration since two sequences are employed. Because the sequences are operated with φ₁=φ₀, the lack of the correspondence does not matter. Additionally, the last phase shifter of the first type I sequence and first phase shifter of the second Type I sequence are combined. Thus to satisfy the necessary values for φ₁+φ₀, twice the power should be applied as when they are separated. Throughout this description, like components at the end of one sequence and the beginning of the next sequence are combined. Nevertheless, it is also possible to use the components separated. The separated and the combined configurations are considered equivalent in the context of the invention.)

As discussed, two Type II sequences also form a half wave plate equivalent. As shown in FIG. 5, electrode control is analogous to two Type I sequences in series. That is electrodes 51 and 52 control θ for positive and negative values respectively; electrodes 53 and 54 control θ₀+θ₁ for positive and negative values respectively; and electrodes 55 and 56 control φ for positive and negative values, respectively.

The sequences are connected in series to produce the desired polarization controller. A single properly controlled sequence functions as a quarter wave plate equivalent and a properly controlled pair of sequences function as a half wave plate equivalent. As previously discussed, the use in series of a quarter wave plate equivalent followed by a half wave plate equivalent allows a varying input polarization state to be converted to a single desired output polarization state. Similarly, the use of four sequences corresponding to a quarter wave plate equivalent (one sequence) followed by a half wave plate equivalent (two sequences) followed by another quarter wave plate equivalent (one sequence) allows the conversion of a varying input polarization state to any desired output polarization state. The choice of using three sequences in series or four depends on the particular application. Generally, the three sequence configuration is useful for example to convert an input signal with a constant polarization state to a desired output state. The four sequence configuration is useful for example to convert input signals with varying polarization to a desired output polarization state.

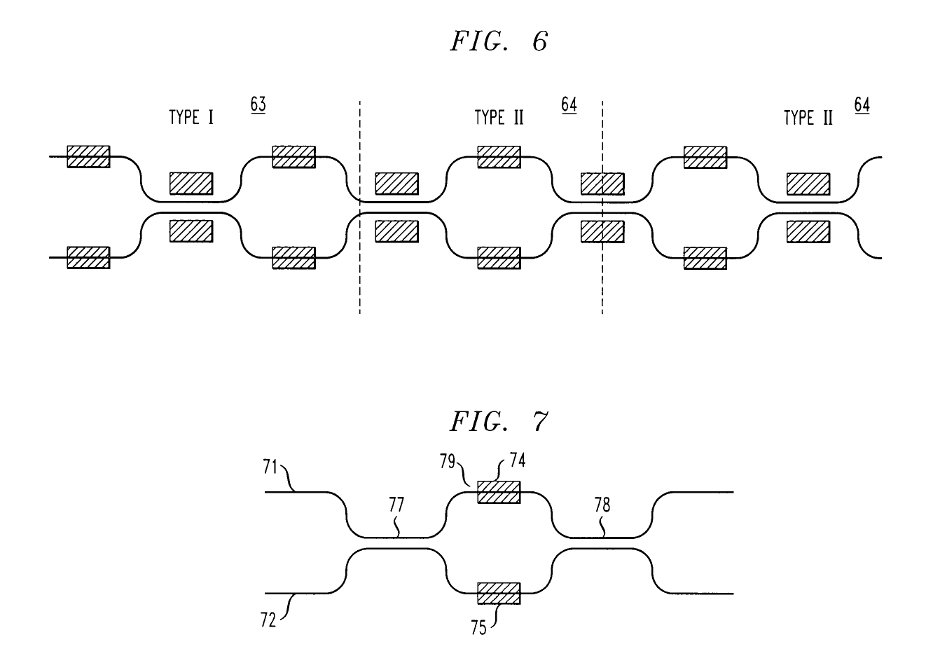

To illustrate further, a quarter wave plate followed by a half wave plate is producible with a three sequence series of all Type I or all Type II sequences. A mixture of sequence types is also useful. Therefore, illustratively, a three sequence series using one Type I and two Type II sequences is also possible. As shown in FIG. 6 the Type I sequence is indicated by 63 and the Type II sequences are denoted at 64 as delimited by dotted lines added solely as a pedagogic aid and not as a component structure. (The electrodes are included for clarity but not denominated.) Similarly, a quarter wave plate followed by a half wave plate is producible, for example, using a Type II followed by two Type I sequences, or by using three Type II sequences. In a corresponding manner a quarter wave plate followed by a half wave plate in turn followed by a quarter wave plate equivalent is formed using four sequences. Generally, four sequences of the same type are employed. However, a Type I followed by two Type II followed by a Type I, or any other combination of Type I and Type II sequences are useful.

The sequences are used to produce a result equivalent to a quarter wave plate. Since a half wave plate γ/2 can be replaced by two quarter wave plates γ/2, two of these sequences in a row (operated as identical quarter wave plates) are used to produce the result equivalent to a half wave plate. By controlling both φ and θ in each sequence, the entire device is operable without reset. To achieve the desirable attributes of reset free operation, it is advantageous to control θ and φ in a Type I sequence as indicated by the following equations:
θ=arcsin [2^{-1/2} sin α]; φ₀=φ₁=arctan(cos α) (1)

Where θ is the coupling strength for the coupler, and φ₀ and φ₁ are the phase shift for the shifter before and after the coupler, respectively.

In the second Type II sequence, the electrodes are controlled in conformance with the second equation:
φ/2=arcsin [2^{-1/2} cos α]; θ₀=θ₁=½ arctan(sin α) (2)

Where φ is the phase shift for the shifter, and θ₀ and θ₁ is the coupling strength for the couplers before and after the shifter, respectively.

Thus as shown by the above equations, a desired output a is controlled by controlling the phase shift angle and coupling strength for the components of the sequence. The final output polarization state from the entire series of sequences such as the series of sequences shown in FIG. 4 is determined in the same manner as if each sequence was the corresponding quarter wave or half wave plate as described in Heismann, supra.

Although the equations discussed above yield a close approximation for determining the output polarization state ultimately achieved, some variation is possible due to variations in components as fabricated in a silica substrate. A control sample is employed to determine the precise coupling strength and phase shift values necessary to yield a specific output polarization state. Typically, the actual phase shift achieved relative to that determined by the above formulae is within 3 percent. Therefore, large corrections are generally not required.

If the input polarization state to a series of sequences is fixed and constant, then it is possible to eliminate the first component of the first sequence if it is a Type I sequence. Thus, for example, if the series of sequences receives its input signal directly from the laser generating the signal, the first component of the first sequence is not needed. Similarly, if a device receiving the signal from the last component in the last sequence of a series is not affected by the relative phase of the incoming signal, it is possible to eliminate this last component if the last sequence is Type I. For example, if a photodetector is directly after the series of sequences ending with a Type I sequence, it is possible to eliminate the last component. If a first or last component of a sequence in a series is eliminated, the sequence with the eliminated component is considered a Type I sequence even though one component is missing.

The components for each sequence are fabricated by conventional techniques as described in Kaminow and Koch, Chapter 8 supra. Generally germanium doped silica regions are employed as waveguides, with silicon dioxide upper and lower cladding used to isolate the waveguide from the heater. Typically, photolithographically defined chromium thin-film heaters are employed. The entire structure is formed on a silicon substrate with the silicon dioxide regions produced by oxidation or chemical vapor deposition. Although silicon based materials are favored, other materials such as other semiconductor materials and other dielectrics such as polymers or silicon nitride are not precluded.

1. A process for operating on an incoming optical signal having a first state of polarization to produce an outgoing optical signal having a second state of polarization different from said first state and further processing said outgoing signal, said process comprising the steps of introducing said incoming signal to a series of sequences, said sequences being Type I sequences, Type II sequences, or a combination of Type I and Type II sequences; controlling said sequences to operate without reset; and further processing said outgoing signal.

2. The process of claim 1 wherein components of said sequences are formed of silicon based materials.

3. The process of claim 1 wherein said series of sequences comprises three sequences.

4. The process of claim 3 wherein said series of sequences comprises a Type I sequence followed by two Type II sequences.

5. The process of claim 3 wherein said series of sequences comprises a Type II sequence followed by two Type II sequences.

6. The process of claim 1 wherein said series of sequences comprises four sequences.

7. The process of claim 6 wherein said series comprises a Type I sequence followed by two Type II sequences followed by a Type I sequence.

8. The process of claim 6 wherein said series comprises a Type II sequence followed by two Type I sequences followed by a Type II sequence.
